(19) United States
(12) Patent Application Publication
(10) Pub. No.: US 2003/0048009 A1
(43) Pub. Date: Mar. 13, 2003

(54) Electronic locking apparatus

(76) Inventors: Yang Gue Kim, Seoul (KR); Won Chol Kim, Gyeonggi-do (KR)

Correspondence Address: DELLETT AND WALTERS, 310 S.W. FOURTH AVENUE, SUITE 1101, PORTLAND, OR, 97204, US

(21) Appl. No.: 09/997,772

(22) Filed: Nov. 29, 2001

(30) Foreign Application Priority Data
Sep. 7, 2001 (KR) 2001-55121

(51) Int. Cl. H02J 1/00

(52) U.S. Cl. 307/149

(57) ABSTRACT

The present invention relates to a locking technology adapted to a place which requires an electronic locking apparatus such as a safe, an entrance door, a drawer, a cabinet, etc., and in particular to an improved electronic locking apparatus capable of preventing an intruder from illegally unlocking a locking apparatus and implementing a complicated and variable communication signal system between an input apparatus and an opening and closing apparatus in an electronic locking apparatus which is formed of an input apparatus and an opening and closing apparatus for implementing an electronic locking apparatus as a reliable locking apparatus.

### BACKGROUND OF THE INVENTION

1. Field of the Invention

The present invention relates to a locking technology adapted to a place which requires an electronic locking apparatus such as a safe, an entrance door, a drawer, a cabinet, etc., and in particular to an improved electronic locking apparatus capable of preventing an intruder from illegally unlocking a locking apparatus and implementing a complicated and variable communication signal system between an input apparatus and an opening and closing apparatus in an electronic locking apparatus which is formed of an input apparatus and an opening and closing apparatus for implementing an electronic locking apparatus as a reliable locking apparatus.

2. Description of the Background Art

Generally, a safe is used for storing an important thing in life and a certain thing which needs a special storing manner. The safe is basically directed to storing a rare thing. Various safes adaptable to various storing situations are manufactured and introduced. For example, a safe which has a good fire resistance and security system and is formed of a special material and apparatus is fabricated based on a user's demand like a home safe, a hospital safe, a wall-mounted safe, a customized safe, etc. The most important thing in the above safes is a security. When a user buys a safe, the user considers an anti-theft function (security function) as the most important factor. Each safe manufacturer fabricates a safe having an excellent security system and sells the products based on their excellent security systems.

In addition, as the safe materials are advanced, the safes are manufactured using a special material which is not easily broken and damaged by an external strong impact or by a certain tool such as a drill. The durability of the safes is excellent with respect to an external impact. Therefore, an inherent unlocking method or a signal transfer system between an external apparatus and an internal apparatus must be known in order for an external intruder to unlock a locking apparatus. The safes are generally implemented based on a dial type, a key type and a button type. In the conventional dial type safe, a locking method is widely open, so that an intruder is capable of easily unlocking the safe. In addition, as the unlocking technique is advanced, the conventional key type safe is easily unlocked. In the button type safe, a user is not needed to carry a certain key. Therefore, it is very convenient and has a good security based on a user's password. Furthermore, the user is capable of set a certain password which is combined in multiple numbers for thereby implementing an excellent security. The conventional digital safe will be described with reference to FIGS. 1A, 1B and 2 through 5. FIG. 1A is a view illustrating a conventional safe. As described earlier, the door opening technique of the dial type safe is widely known, so that an external intruder can easily open the door of the locking apparatus. In addition, FIG. 1B is a view illustrating a conventional digital safe. In the case of the safe locking apparatus which uses a conventional electronic key pad, the door of the safe includes an electronic key pad, an input apparatus having a power (battery) and a handle. Therefore, the door is opened based on the input of the password authorized by a user. However, in the case of all kinds of button input type digital safes which are currently commercial, even when an intruder does not know the password, the intruder can easily open the door by connecting a power to a communication line which connects the inner and outer sides of the safe. The above problem is not well known to others. However, when the above problems are known to others, all kinds of the digital safes which are currently commercial may disappear in the market due to a big problem in the security. The inventor of the present invention has a demonstration for opening the safes manufactured by well-known manufacturers within 30 seconds through 1 minute using a simple tool such as a portable battery, a power cable, a driver and a nipper. At this time, many persons attended the demonstration are surprised.

The critical problems of the conventional digital safe will be described in detail with reference to FIGS. 2 through 5.

FIG. 2 is a view illustrating an example of a conventional digital safe and a door opening control method. The conventional digital safe 100 includes an input apparatus 110 formed of a key pad 111, a display unit 112, a controller 113, and a power unit 114, and an opening and closing apparatus 120 formed of a power amplifier 121 and an opening and closing unit 122. The door of the safe is opened in such a manner that a registered password of the safe is inputted, a power signal of the power unit 114 is inputted by the controller 113, and a safe opening signal is transferred to the power amplifier for thereby operating a solenoid coil of the opening and closing unit 122 and unlocking the locked state of a motored gear apparatus or a spring and a cam structure. In addition, FIG. 3 is a view illustrating an external type of a power amplifier. The safe door opening method is the same as the example of FIG. 2. Namely, FIG. 2 is a view illustrating a conventional digital safe having an internal type power amplifier. FIG. 3 is a view illustrating a conventional digital safe having an external type power amplifier.

As shown in FIG. 2, in the conventional safe door opening method, a user inputs a password registered by a user using the keypad 111, and the controller 113 verifies the user's password in Steps A01 and B01. A result of the verification is displayed on the display unit 112. In Steps A03 and A04, a power of the power unit 114 is supplied to a plurality of lines which connect the inner and outer sides of the safe. In Step S05, the power is amplified for thereby operating the opening and closing unit 122, so that the door is opened.

As shown in FIG. 3, in the conventional safe door opening method, a user inputs a password using the keypad 211, and the controller 213 verifies the user's password in Step B01. A result of the verification is displayed on the display unit 212 in Step B02. When the password is verified, a power is supplied in Step B03. A power application is performed with respect to a plurality of lines which connect the inner and outer sides of the safe in Steps B04 and B05 for thereby operating the opening and closing unit 221, so that the door is opened.

The above-described digital type locking apparatus is adapted to the safe as well as an entrance door, a cabinet or a drawer as shown in FIGS. 1C through 1E.

In the conventional digital type electronic locking apparatus, a signal type of each line between an input apparatus (external) and an opening and closing apparatus(internal) as shown in FIGS. 2 and 3 is shown in Table 1.

TABLE 1

| | | Variation of signal | Number of | |
|---|---|---|---|---|
| Line number | Type | by password | lines | Function |
| A01, B01 | complicated | varied | 7˜8 lines | user's password input |
| | digital clock signal | | | |
| A02, B02 | simple power | constant | 2˜20 lines | Display of result of |
| | | | | password verification |
| A03, B03 | simple power | constant | 4˜6 lines | Power supply when |
| | | | | verified |
| A04, B04 | simple power | constant | 2 lines | power amplification |

As shown in Table 1, in the electronic locking apparatus in which the conventional safe is adapted, the signal transferred to the opening and closing apparatus of the safe in an external input apparatus of the safe is a simple power type. The signal inputted based on the password is constant. If a certain person knows the above-described principle, the person disassembles the panel of the input apparatus using a driver and connects a power cable of a portable small size battery to the power lines (2˜4 lines) for thereby easily opening the door of the safe.

The above-described operation will be explained in detail with reference to FIGS. 4 and 5. FIG. 4 is a view of an example of an external abnormal unlocking method of a conventional electronic locking apparatus. FIG. 4 is a view illustrating the construction of two transmission lines between the input apparatus 10 and the opening and closing apparatus 20. FIG. 5 is a view illustrating the construction of four lines. As shown in FIG. 4, the power is supplied through the transmission lines between the input apparatus 10 and the opening and closing apparatus 20 based on a simple power supply method (plus power (+) and minus power (−). Therefore, in order to illegally unlock the safe, a certain power 3 (portable battery) is connected to the transmission lines between the input apparatus 10 and the opening and closing apparatus 20. In detail, the plus power is connected to the line 1 and the minus power is connected to the line 2 for thereby easily opening the door by driving the opening and closing apparatus 20. In the case of four lines, as shown in FIG. 5, the power 3 is connected to four transmission lines between the input apparatus 10 and the opening and closing apparatus 20 by an intruder, and a plus power or minus power is selectively applied to a corresponding line for thereby easily opening the safe by operating the opening and closing apparatus 20. Namely, in the electronic locking apparatus adapted to a conventional safe, the plus power is connected to the line 1, the minus power is connected to the line 2, the minus power is connected to the line 3, and the plus power is connected to the line 4. In this case, it is easily open the safe by simply applying a power signal to a corresponding line.

Therefore, the conventional electronic locking apparatus is not stable with respect to an illegal intruder and does not properly operate due to the above-described problems.

### SUMMARY OF THE INVENTION

Accordingly, it is an object of the present invention to provide an electronic locking apparatus capable of preventing an illegal unlocking (door opening) of an electronic locking apparatus adapted to a safe, an entrance door, a drawer, a cabinet, etc. and implementing a stable electronic locking apparatus as a reliable security apparatus.

It is another object of the present invention to provide an electronic locking apparatus capable of preventing an illegal opening of a locking apparatus by providing a complicated signal system and a certain variation in a signal based on a password line an inherent function of an electronic locking apparatus by changing a signal transfer system between an external input apparatus and an internal opening and closing apparatus of an electronic locking apparatus.

It is still another object of the present invention to provide an electronic locking apparatus capable of preventing a leakage of a password and an illegal opening of a door of a safe using a method capable of performing bi-directional wireless communication between an input apparatus and an opening and closing apparatus by forming a controller in the input apparatus and opening and closing apparatus.

To achieve the above objects, according to a first aspect of the present invention, in an electronic locking apparatus for locking the inner and outer sides of a boundary frame of a certain structure, there is provided an electronic locking apparatus which includes:

an input apparatus installed in an outer portion of the boundary frame of the structure for receiving a certain information for verifying a user's password and transmitting a signal corresponding to the information inputted;

a controller installed in an inner portion of the boundary frame and connected with the input apparatus by a plurality of lines for receiving the signal from the input apparatus and verifying the user;

a power amplifier for performing a power amplification when a power is supplied from the controller when verified; and

an opening and closing unit for receiving a power amplified by the power amplifier and opening the door.

According to a second aspect of the present invention, the electronic locking apparatus is adapted to a safe, an entrance door, a drawer and a cabinet.

According to a third aspect of the present invention, in the electronic locking apparatus, the input apparatus includes a power unit which supplies an inner power, for commonly supplying the power to the input apparatus and the opening and closing apparatus.

According to a fourth aspect of the present invention, a unit for receiving an information for verifying a user such as a password in the input apparatus is a keypad for a button input.

According to a fifth aspect of the present invention, a unit for receiving an information for verifying a user such as a password in the input apparatus is a card input unit.

According to a sixth aspect of the present invention, a unit for receiving an information for verifying a user such as a password in the input apparatus is implemented by a keypad for a button input and a card input unit, and the keypad and card input unit may be co-used or may be independently used.

To achieve the above objects, according to a seventh aspect of the present invention, in an electronic locking apparatus for locking the inner and outer sides of a boundary frame of a certain structure, there is provided an electronic locking apparatus which includes:

an input apparatus installed in an outer portion of the boundary frame and including:

a keypad which receives a password information for verifying a user such as a password;

a display unit for displaying an operation information;

a first transmission unit for transmitting a wireless signal;

a first receiving unit for receiving a wireless signal;

a first power unit for supplying an internal power;

a first controller for converting a signal corresponding to a password inputted through the keypad into a wireless signal and transmitting the same through the first transmission unit, receiving a display control signal received through the first receiving unit and driving the display unit; and

an opening and closing apparatus installed in an inner portion of the boundary frame and including:

a second transmission unit for transmitting a wireless signal;

a second receiving unit for receiving a wireless signal;

a second power unit for supplying an inner power;

a second controller for verifying a password inputted from the first controller through the second receiving unit and transmitting a result of the verification to the first controller through the second transmission unit and displaying the result of the same;

a power amplifier for performing a power amplification operation when a power is supplied from the second controller based on a verification; and

an opening and closing unit for opening a door by receiving a power amplified by the power amplifier.

According to an eighth aspect of the present invention, the electronic locking apparatus is adapted to a sage, an entrance door, a drawer and a cabinet.

According to a ninth aspect of the present invention, a wireless communication adapted to the first transmission unit, the second transmission unit, the first receiving unit and the second receiving unit installed in the input apparatus and the opening and closing apparatus is implemented by one selected from an IrDA, RF and bluetooth.

### BRIEF DESCRIPTION OF THE DRAWINGS

The present invention will become better understood with reference to the accompanying drawings which are given only by way of illustration and thus are not limitative of the present invention, wherein;

FIG. 1A is a view illustrating a conventional safe;

FIG. 1B is a view illustrating a conventional electronic safe;

FIG. 1C is a view illustrating a door in which a conventional electronic locking apparatus is adapted;

FIG. 1D is a view illustrating a cabinet in which a conventional electronic locking apparatus is adapted;

FIG. 1E is a view illustrating a drawer in which a conventional electronic locking apparatus is adapted;

FIG. 2 is a schematic view illustrating an example of a conventional digital safe and a door open control method;

FIG. 3 is a view illustrating another example of a conventional digital safe and a door open control method;

FIG. 4 is a view illustrating an example of an external abnormal unlocking method of a conventional electronic locking apparatus;

FIG. 5 is a view illustrating another example of an external abnormal unlocking method of a conventional electronic locking apparatus;

FIG. 6 is a view illustrating the construction of an electronic locking apparatus according to an embodiment of the present invention and a wire communication method between an external input apparatus and an internal opening and closing apparatus; and

FIG. 7 is a view illustrating the construction of an electronic locking apparatus according to another embodiment of the present invention and a wireless communication method between an external input apparatus and an internal opening and closing apparatus.

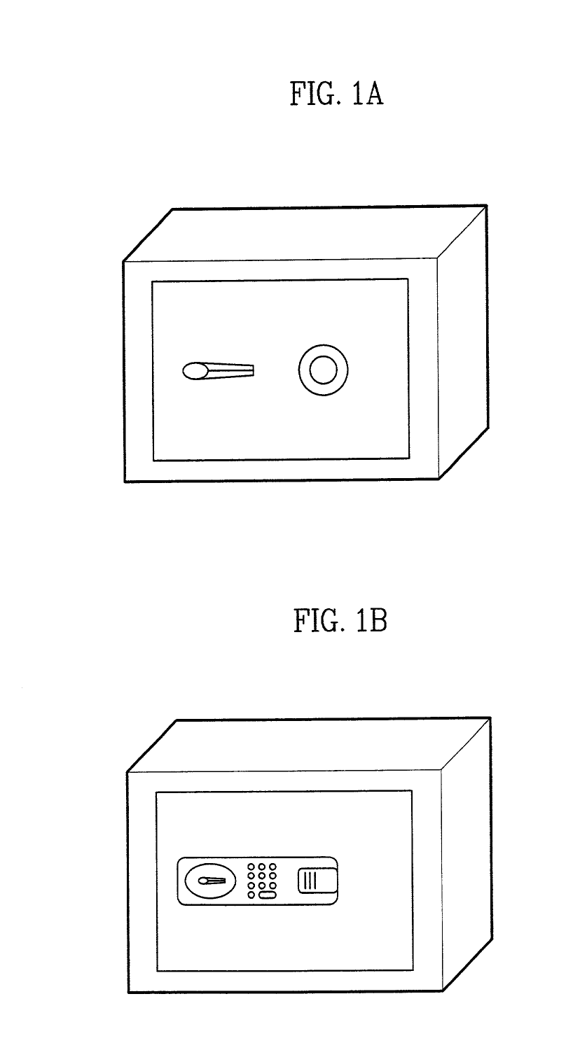

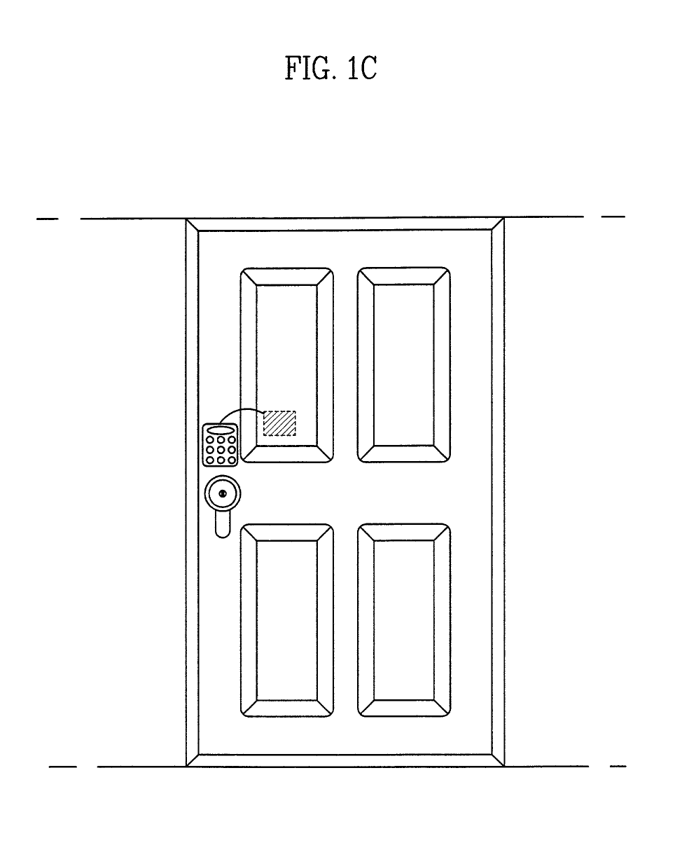

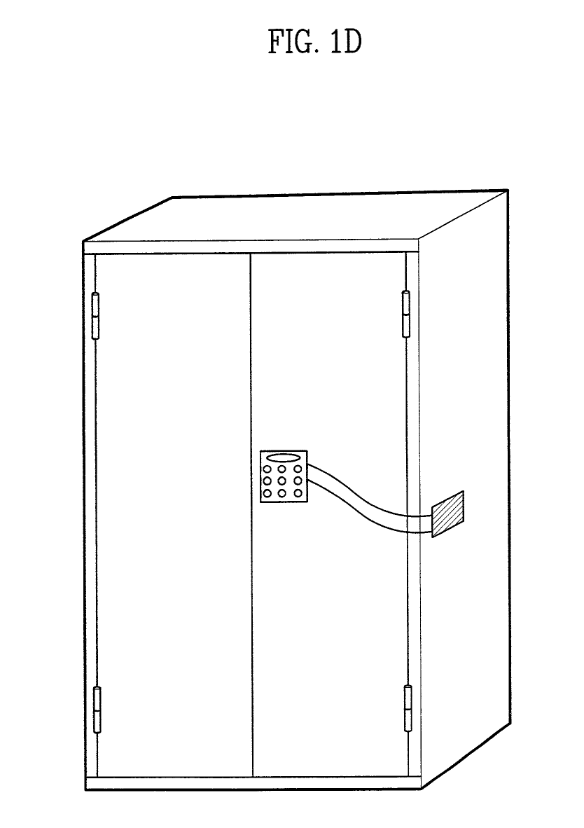

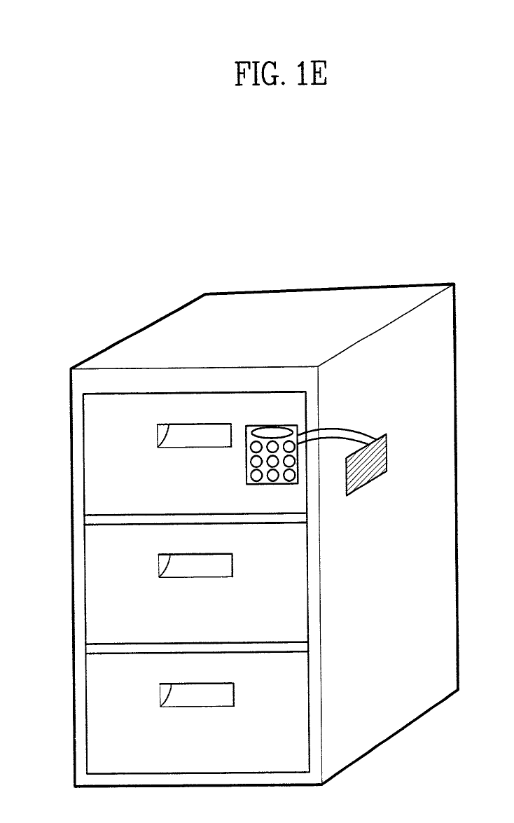

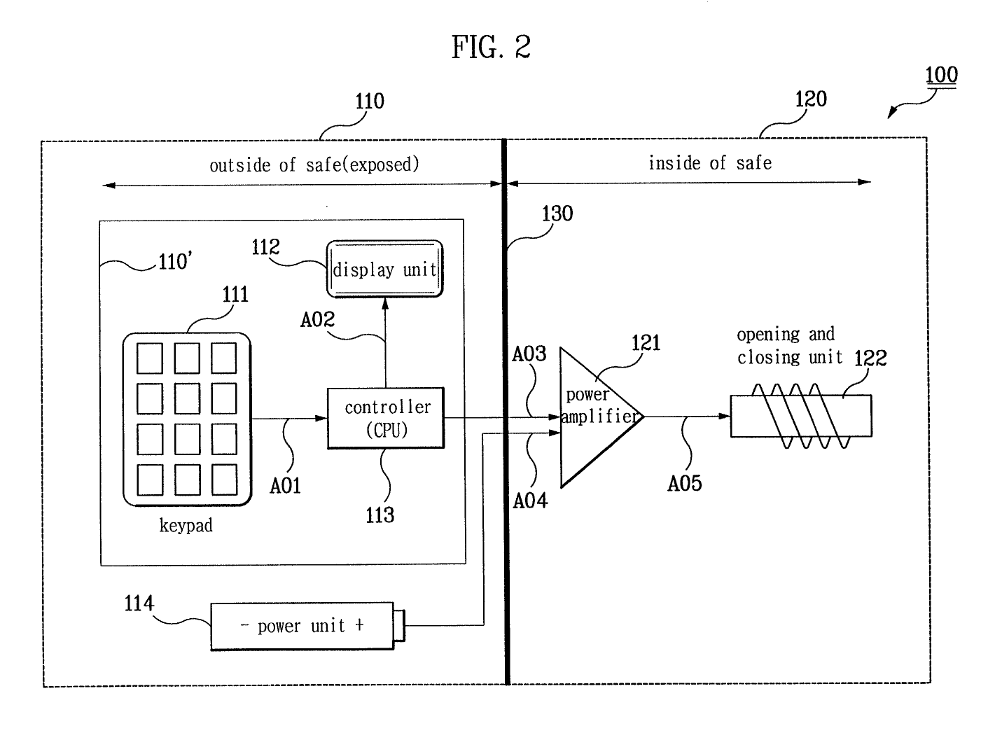

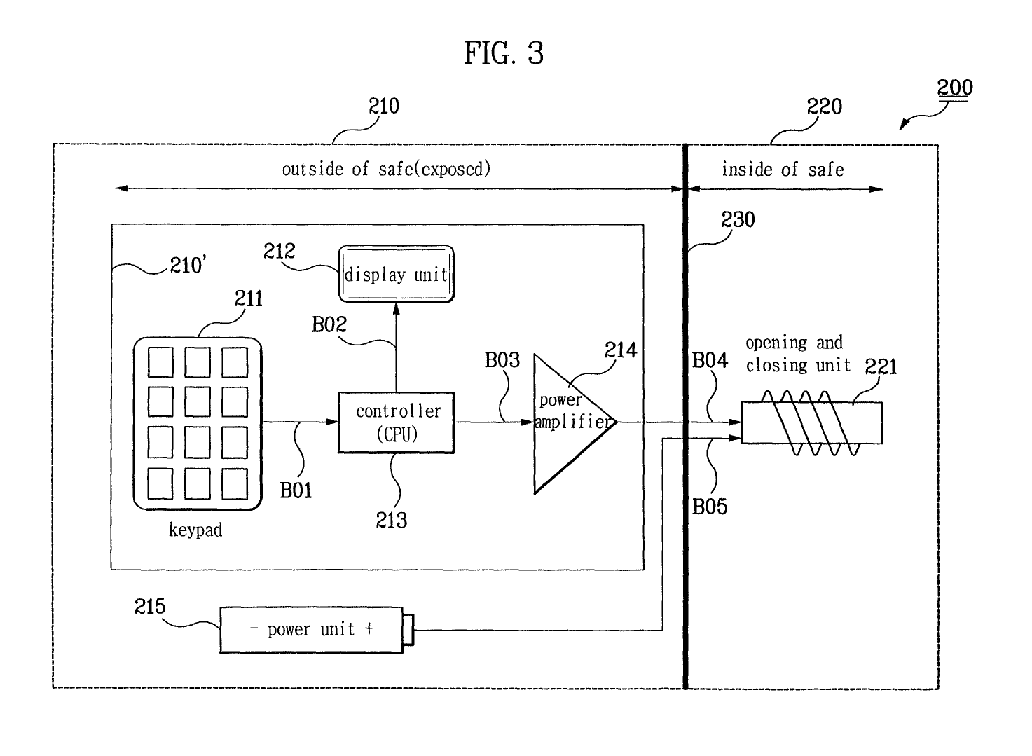

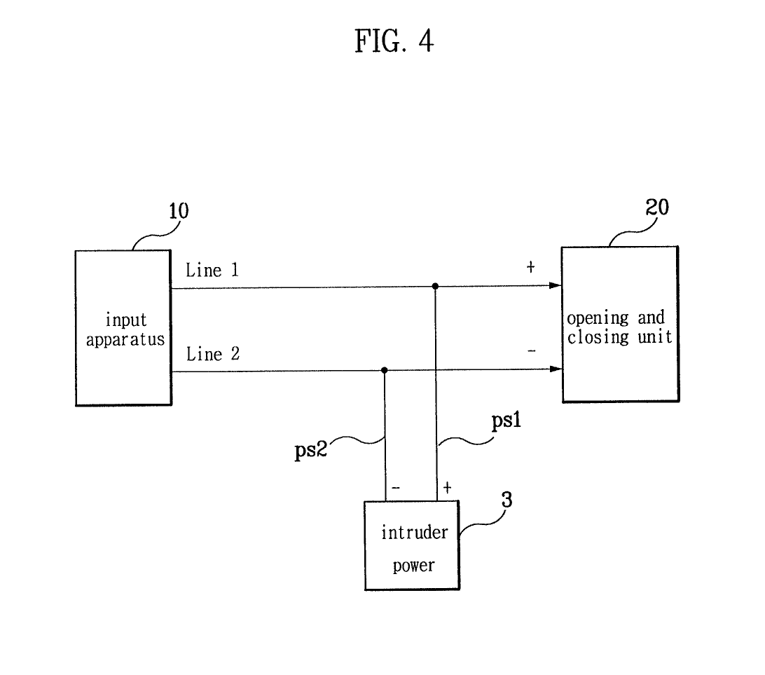

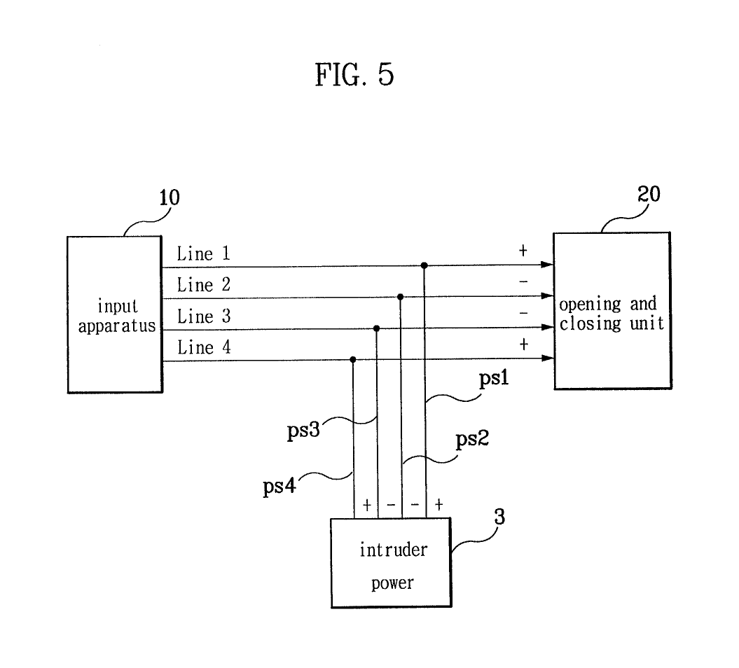

### DETAILED DESCRIPTION OF THE PREFERRED EMBODIMENTS

The embodiments of the present invention will be described with reference to the accompanying drawings. In the drawings, the same elements are given the same numeral numbers even when the same elements are depicted in other drawings. In addition, the detailed known functions and constructions which are judged to be unclear for describing the subject matters of the present invention will be omitted.

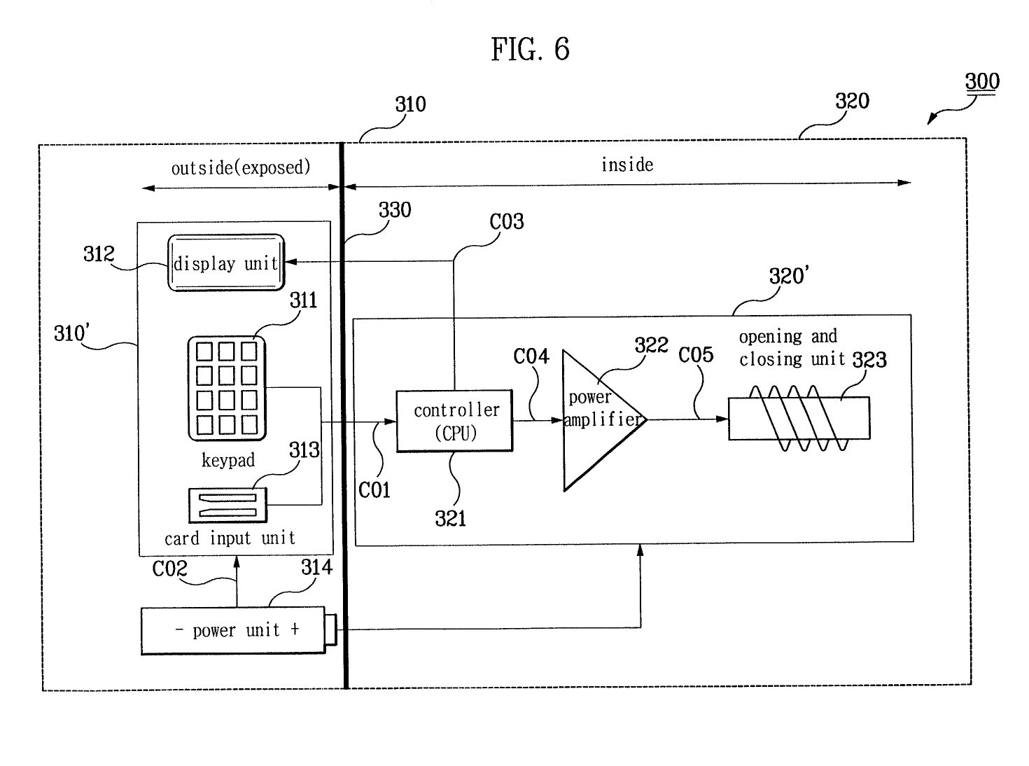

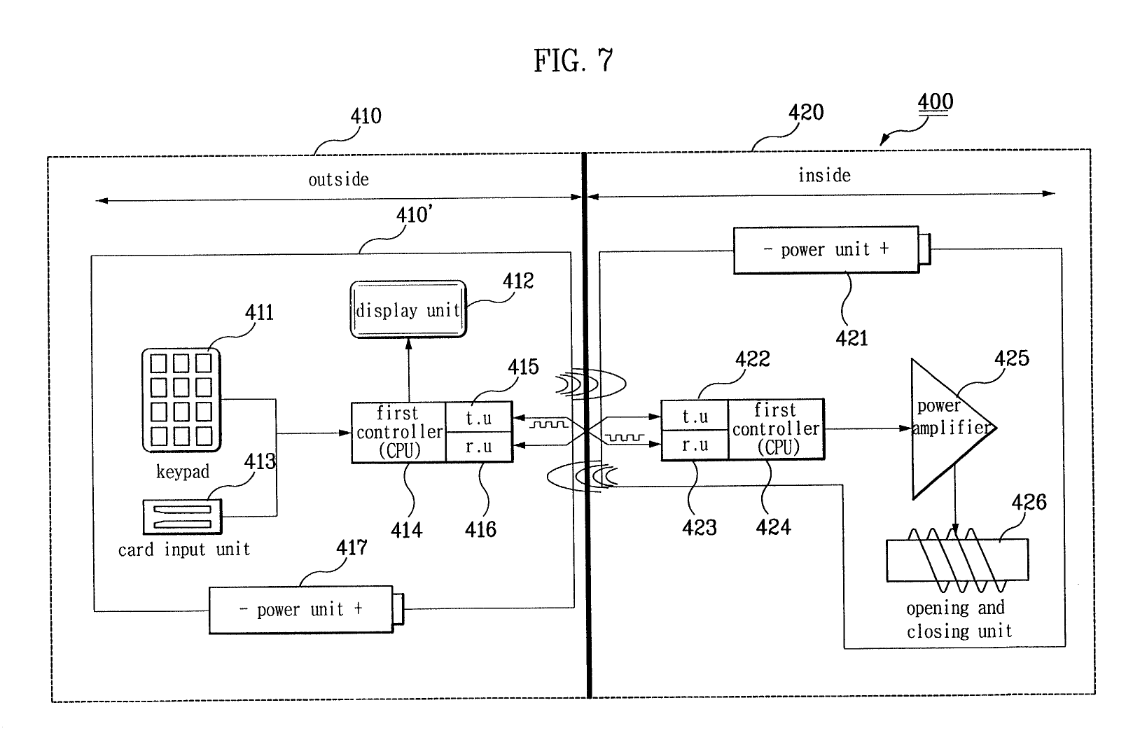

As shown in FIG. 6 or 7, the electronic locking apparatus according to the present invention includes an input apparatus provided outside a boundary frame 330 of a structure and an opening and closing apparatus provided inside the boundary frame 330 of the structure. As shown in FIG. 6, the input apparatus and opening and closing apparatus are implemented by one central processing unit (CPU). In another embodiment, as shown in FIG. 7, the CPU may be implemented by each controller. The latter case, a communication between the input apparatus and the opening and closing apparatus may be implemented by a wireless communication and may adapt a bidirectional wireless communication method such as an IrDA, RF, bluetooth, etc.

The electronic locking apparatus and operation of the same according to the present invention will be described in detail with reference to the accompanying drawings. First, FIG. 6 is a view illustrating the construction of an electronic locking apparatus and a wire communication method between an external input apparatus and an internal opening and closing apparatus according to a preferred embodiment of the present invention. The input apparatus 310 exposed to the outside of the electronic locking apparatus 300 includes a keypad 311, a display unit 312, a card input unit 313 and a power unit 314. In addition, the opening and closing apparatus 320 installed in the interior of the electronic locking apparatus 300 includes a controller 321, a power amplifier 322 and an opening and closing unit 323 for thereby forming an internal type controller of the electronic locking apparatus. In the electronic locking apparatus according to the present invention, the controller 321 is internally installed in such a manner that a signal system from an input apparatus to the controller is varied to a complicated signal system based on the password as seen in Table 1. As shown in FIG. 6, in the electronic locking apparatus 300 according to a preferred embodiment of the present invention, when a user inputs a user's password registered using the keypad 311 or inputs a card using the card input unit 313, a digital clock signal corresponding to the password is applied to the controller installed in the interior of the system through a line C01. In this case, the line C01 is formed of a plurality of lines, preferably, 7˜8 lines. The controller 321 verifies the inputted user's password and transfers a result of the verification through the line C03, and the display unit 312 displays the result of the same. If verified, a power is supplied to the power amplifier 322 through the line C04. The power amplifier 322 performs a power amplification operation for thereby supplying a driving power to the opening and closing unit 323 through the line C05 for thereby driving the opening and closing unit 323, so that the door of the safe is opened. At this time, the power supply is implemented in the panel of the external input apparatus for thereby commonly supplying the power to the input apparatus 310 and the opening and closing apparatus 320. In addition, the input apparatus may be implemented by both the keypad 311 and the card input unit 313 or separately by the both.

In the electronic locking apparatus according to a preferred embodiment of the present invention, since the controller is internally installed, a signal line system between the external input apparatus 310 and the internal opening and closing apparatus 320 is complicated and is varied based on the password, so that it is impossible to unlock the locking apparatus without using an authorized password.

FIG. 7 is a view illustrating the construction of an electronic locking apparatus and a wireless communication method between an external input apparatus and an internal opening and closing apparatus according to a preferred embodiment of the present invention. The input apparatus 410 installed outside the electronic locking apparatus includes a keypad 411, a display unit 412, a card input unit 413, a first controller 414, a transmission unit 415, a receiving unit 416, and a power unit 417. The opening and closing apparatus installed inside the electronic locking apparatus includes a power unit 421, a transmission unit 422, a receiving unit 423, a second controller 424, a power amplifier 425 and an opening and closing unit 426. As shown in FIG. 7, in the electronic locking apparatus according to another preferred embodiment of the present invention, the controller is installed in each of the input apparatus 410 and the opening and closing unit 420. Namely, two controllers are driven. The first controller 414 installed in the input apparatus 410 converts a signal corresponding to the password inputted through the keypad 411 or the card input unit 413 into a wireless signal and transfers the wireless signal to the second controller 424 through the transmission unit 415. A display control signal is received from the second controller 424 through the receiving unit 416 and is displayed on the display unit 412. The second controller 424 installed in the opening and closing unit 420 verifies the password inputted from the first controller 414 through the receiving unit 423 and transfers a result of the verification to the first controller 414 through the transmission unit 422 for thereby displaying the signal and supplies the power to the power amplifier for thereby driving the opening and closing unit 426, so that the door is opened. In addition, the power units 417 and 421 are installed in each of the input apparatus 410 and the opening and closing unit 420, so that a driving power is supplied to a corresponding element, respectively.

As shown in FIG. 7, in the electronic locking apparatus, the signal transfer system between the input apparatus and the opening and closing apparatus is implemented based on a wireless communication, so that an excellent security is implemented with respect to the leakage of the password compared to the wire communication method.

The electronic locking apparatus according to the present invention is widely adapted to the safes and various locking systems which need the locking apparatus and may be used as a locking apparatus of a boundary frame of a certain structure.

In addition, as shown in FIG. 7, when a certain card is used in the wireless communication system in the present invention, the user must carry a card reader and the card, so that the user feels inconvenience. In this case, as shown in FIG. 7, the electronic locking apparatus in which the card input units 313 and 314 are omitted may be implemented.

In the present invention, a communication transfer system between the inner and outer sides of the electronic locking apparatus is complicated and varied, so that it is possible to prevent an illegal unlocking operation (illegal door opening) of the electronic locking apparatus installed in a safe, entrance door, drawer, cabinet, etc. In addition, in the present invention, the electronic locking apparatus may be implemented as a more reliable locking apparatus.

In addition, a signal transfer system between an external input apparatus and an internal opening and closing apparatus of the structure in which the electronic locking apparatus is adapted is changed differently from the conventional art, so that it is possible to prevent an illegal unlocking of the locking apparatus by providing a certain complexity and a certain variation to the signal transfer system based on the password like an inherent function of the electronic locking apparatus.

In the present invention, the controller is installed in both the input apparatus and the opening and closing apparatus, and a bidirectional wireless communication is implemented between the same, so that it is possible to prevent any leakage of the password and an illegal unlocking of the locking apparatus.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. In an electronic locking apparatus for locking the inner and outer sides of a boundary frame of a certain structure, an electronic locking apparatus, comprising:
an input apparatus installed in an outer portion of the boundary frame of the structure for receiving a certain information for verifying a user's password and transmitting a signal corresponding to the information inputted;
a controller installed in an inner portion of the boundary frame and connected with the input apparatus by a plurality of lines for receiving the signal from the input apparatus and verifying the user;
a power amplifier for performing a power amplification when a power is supplied from the controller when verified; and
an opening and closing unit for receiving a power amplified by the power amplifier and opening the door.

2. The apparatus of claim 1, wherein said electronic locking apparatus is adapted to a safe, an entrance door, a drawer and a cabinet.

3. The apparatus of claim 2, wherein in the electronic locking apparatus, the input apparatus includes a power unit which supplies an inner power, for commonly supplying the power to the input apparatus and the opening and closing apparatus.

4. The apparatus of claim 3, wherein a means for receiving an information for verifying a user such as a password in the input apparatus is a keypad for a button input.

5. The apparatus of claim 4, wherein a means for receiving an information for verifying a user such as a password in the input apparatus is a card input unit.

6. The apparatus of claim 5, wherein a means for receiving an information for verifying a user such as a password in the input apparatus is implemented by a keypad for a button input and a card input unit, and the keypad and card input unit may be co-used or may be independently used.

7. In an electronic locking apparatus for locking the inner and outer sides of a boundary frame of a certain structure, an electronic locking apparatus, comprising:
an input apparatus installed in an outer portion of the boundary frame and including:
a keypad which receives a password information for verifying a user such as a password;
a display unit for displaying an operation information;
a first transmission unit for transmitting a wireless signal;
a first receiving unit for receiving a wireless signal;
a first power unit for supplying an internal power;
a first controller for converting a signal corresponding to a password inputted through the keypad into a wireless signal and transmitting the same through the first transmission unit, receiving a display control signal received through the first receiving unit and driving the display unit; and
an opening and closing apparatus installed in an inner portion of the boundary frame and including:
a second transmission unit for transmitting a wireless signal;
a second receiving unit for receiving a wireless signal;
a second power unit for supplying an inner power;
a second controller for verifying a password inputted from the first controller through the second receiving unit and transmitting a result of the verification to the first controller through the second transmission unit and displaying the result of the same;
a power amplifier for performing a power amplification operation when a power is supplied from the second controller based on a verification; and
an opening and closing unit for opening a door by receiving a power amplified by the power amplifier.

8. The apparatus of claim 7, wherein said electronic locking apparatus is adapted to a sage, an entrance door, a drawer and a cabinet.

9. The apparatus of claim 8, wherein a wireless communication adapted to the first transmission unit, the second transmission unit, the first receiving unit and the second receiving unit installed in the input apparatus and the opening and closing apparatus is implemented by one selected from an IrDA, RF and bluetooth.
